(19) United States
(12) Patent Application Publication
(10) Pub. No.: US 2023/0203925 A1
(43) Pub. Date: Jun. 29, 2023

(54) POROSITY PREDICTION METHOD BASED ON SELECTIVE ENSEMBLE LEARNING

(71) Applicant: China University of Petroleum (Huadong), Qingdao (CN)

(72) Inventors: Youxiang DUAN, Qingdao (CN); Yanfei Wang, Qingdao (CN)

(73) Assignee: China University of Petroleum (Huadong), Qingdao (CN)

(21) Appl. No.: 17/234,724

(22) Filed: Apr. 19, 2021

(30) Foreign Application Priority Data
Jun. 24, 2020 (CN) 2020105905759

(51) Int. Cl. E21B 43/16; G06N 3/045

(52) U.S. Cl. CPC E21B 43/16; G06N 3/045; E21B 2200/22

(57) ABSTRACT

A porosity prediction method based on selective ensemble learning is disclosed. On the basis of the typical machine learning method, the principal component analysis method is used to analyze data from support vector machines, radial basis functions. A group of excellent individual learning models are selected from the classical models such as RBF (RBF) neural network, random forest, ridge regression and K nearest neighbor regression to form the ensemble learning model. The weights of individuals in the ensemble model are obtained by the method of “principal component weight average” and the output of the ensemble learning model is finally obtained by the method of weighted average. The PCA-SEN model overcomes the shortcomings of a single model and has strong generalization ability. This method is used to predict reservoir porosity in order to get more accurate prediction results.

### FIELD OF THE INVENTION

The disclosure relates to the field of machine learning, and more specifically, to a porosity prediction method based on selective ensemble learning.

### BACKGROUND OF THE INVENTION

When machine learning is used to solve practical problems, a single learner has some disadvantages such as poor universality and low stability. In this case, ensemble learning emerges as the times require. Ensemble learning is a method to achieve better prediction performance than a single learner by combining multiple individual learners into one prediction model. Currently, integrated learning has been widely used in many fields, aiming at classification problems, such as handwriting recognition, face recognition, image recognition, etc., integrated learning has achieved good results, aiming at regression problems. The research of ensemble learning in this field started late, and the research results are relatively few, such as power load forecasting, financial field and so on. But there are still some problems that need to be solved in ensemble learning. In practical applications, there are many problems such as less training samples, low accuracy and noise, which increases the complexity of algorithm design. From the point of view of ensemble learning itself, it is still difficult to construct the learner with high accuracy and great difference. Secondly, with the increase of the number of individual learners, the computational speed of the algorithm becomes slower and the storage cost becomes larger. The emergence of selective ensemble learning provides a new way to solve the problems that cannot be solved by general ensemble learning. Selective ensemble learning refers to that when performing classification or regression prediction, a number of trained individual learners are first “selected” from individual learners with large differences and strong generalization ability. The selected individual learners are then “combined” and the combined screening model have a higher prediction precision than the full-scale model. Selective integration can be regarded as the improvement of integration learning, and its performance is better than that of ordinary integration learning. In recent years, some research achievements have been made in all fields, such as face recognition, water quality detection, time sequence prediction, etc. with the rapid development of selective ensemble learning, It has more and more obvious functional advantages, has been widely used in machine learning research field. However, the selective ensemble learning is introduced into reservoir parameter prediction, and there are few related research data at present.

Porosity, as an important reservoir parameter, is the prerequisite for oil and gas exploration and development and the basis and key for interpretation of strata. It is very important and necessary to build a geological model to predict the porosity of unknown fields by using the data of existing wells. Conventional porosity prediction methods, such as inversion method, empirical formula method or multiple regression method, are simple in principle and easy to operate, In spite of that fact that the single machine learn methods such as artificial neural network, support vector machine, ridge regression and the like can solve the complex nonlinear map problem and have higher interpretation precision than the conventional methods, However, there are some disadvantages such as poor universality and low stability. Therefore, it is very important to design a model that can accurately predict the porosity.

### SUMMARY OF THE INVENTION

Aiming at the solving problems of the existing porosity prediction methods, the present disclosure provides a porosity prediction method based on selective integrated learning. In the method, base on the research and analysis of typical machine learning method, a method of “principal component method analysis” is adopted to analyze data, and a group of excellent individual learning models are selected from the classical models such as RBF (RBF) neural network, random forest, ridge regression and K nearest neighbor regression to form the ensemble learning model. The weights of individuals in the ensemble model are obtained by the method of “principal component weight average” and the output of the ensemble learning model is finally obtained by the method of weighted average, which is called PCA-SEN model. This method is used to predict reservoir porosity in order to obtain more accurate prediction results. The method mainly includes:

A. Studying and analyzing a typical machine learning method, and establishing the individual learning model;

B. selecting a strategy by the principal component analysis, and selecting part of the individual learning models to form the ensemble learning model;

C. adopting the combination strategy of the principal component weight average method to obtain the weight of the individual learning model, and adopting the weighted average method to obtain the output of the ensemble learning model.

In part A, through research comparison and experimental analysis, advantages and disadvantages of individual learning models formed by different single machine learning methods in prediction are summarized. The single machine learning method adopted in the present invention includes support vector machine, RBF neural network, random forest, ridge regression and K nearest neighbor regression. Their advantages and disadvantages are as follows:

\textcircled{1} Support Vector Machine

Advantages: Suitable for small sample nonlinear function fitting; strong generalization ability; local optimal solution is global optimal solution.

Deficiencies: It is difficult to solve the problem of large-scale training samples and multi-classification; it is sensitive to missing data and sensitive to the selection of parameters and kernel functions.

\textcircled{2} RBF Neural Network

Advantages: It has strong approximation ability, can approach arbitrary nonlinear function with arbitrary precision, fast convergence speed, no local extreme value exists.

Deficiencies: The fault tolerance is weak, especially when the input samples have large errors or individual errors, the output of the network varies greatly; in the case of more training samples, the network scale is large.

\textcircled{3} Random Forest

Advantages: Simple, easy to implement, low computation cost; able to process data of very high dimensions without feature selection; strong generalization ability; insensitive to missing values;

Deficiencies: Over-fitting is likely to occur in classification or regression problems with high noise; poor classification results for small data or low-dimensional data; and data with different values of attributes. The attributes with more values will have a greater impact on the random forest.

\textcircled{4} Ridge Regression

Advantages: The problem of collinearity among variables can be solved; the problem of more features than sample size can be solved.

Deficiencies: The model is poorly interpreted and easy to over-fit.

\textcircled{5} K Nearest Neighbor Regression

Advantages: Easy to implement, no need to estimate parameters, no need to train; training time complexity is relatively low; suitable for the case of large sample size.

Deficiencies: When the number of features is very large, the calculation is large; when the sample is unbalanced, the accuracy of prediction for rare categories is low; when lazy learning method is used, the prediction speed is relatively slow.

In part B, the principal component analysis method is use to select strategies, a group of excellent individual learning models are selected from the classical models such as Support Vector Machine, RBF Neural Network, Random Forest, Ridge Regression and K Nearest Neighbor Regression to form the ensemble learning model.

The principal component method analysis method includes:

training the data by using 5 kinds of machine learning methods for training learning, and carrying out a forecast analysis;

comparing the predicted value obtained by adopting different machine learning methods for each piece of training data with the actual value, and selecting the machine learning method corresponding to the best predicted value as the method used for the piece of data;

counting the number of samples passed by each machine learning method and counting the proportion in the total training samples. Finally, several optimal machine learning methods are selected according to the proportion to form the individual learning model in the ensemble learning model.

In part C, the weight of individual learning model is obtained by combining the strategy of “principal component weight average,” and the output of ensemble learning model is obtained by weighted average method.

The “principal component weight average” method includes modeling and predicting the training data by using an individual learner, and the predicted value obtained by using different individual learning models for each training data is compared with the true value;

selecting the individual learning model corresponding to the best prediction value as the model used for the piece of data, and counting the number of samples passed by each learning model and the proportion in the total training samples, i.e. the weight factor of the learning model.

### BRIEF DESCRIPTION OF THE DRAWINGS

FIG. 1 is an overall framework diagram of porosity prediction based on PCA-SEN model according to the present disclosure.

FIG. 2 is a first schematic diagram of a selection strategy in the selective ensemble learning method of the present disclosure.

FIG. 3 is the second schematic diagram of a combination strategy in the selective ensemble learning method of the present disclosure.

### DETAILED DESCRIPTION OF EMBODIMENTS

In order to make the object and technical scheme of the present invention more clear, the implementation method of the present invention will be described in detail with reference to the accompanying drawings.

The overall idea of the present invention is to provide a selective integrated learning method for predicting porosity in order to solve the problems of low fault tolerance, over-fitting and the like existing in a single machine learning method for predicting porosity. Based on the research and analysis of typical machine learning method, and under principal component analysis, a group of excellent individual learn models are selected from classical models such as support vector regression, RBF neural network, random forest, ridge regression and K-nearest neighbor regression to form an integrated learning model. The weight of individual learning model in ensemble learning model is obtained by the method of “principal component weight average” and the output of ensemble learning model is obtained by the method of weighted average. This model is called PCA-SEN model for short. By using this model to predict reservoir porosity, more accurate prediction results can be obtained.

The application of the PCA-SEN model in porosity prediction of the present invention will be explained and described with reference to the drawings.

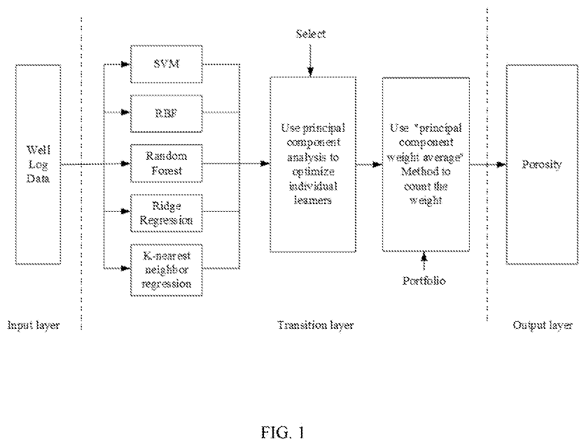

FIG. 1 is an overall framework of porosity prediction of the PCA-SEN model of the present invention, and as shown in the figure, it mainly includes the following aspects:

\textcircled{1} The log data are input into SVM, RBF neural network, random forest, ridge regression and K-nearest neighbor regression models respectively for prediction.

\textcircled{2} The prediction results were selected by the method of “principal component analysis” and the individual learning model in the selective ensemble learning model was selected.

\textcircled{3} The optimal individual learning model is combined by the method of “principal component weight average” and the final combination results are output.

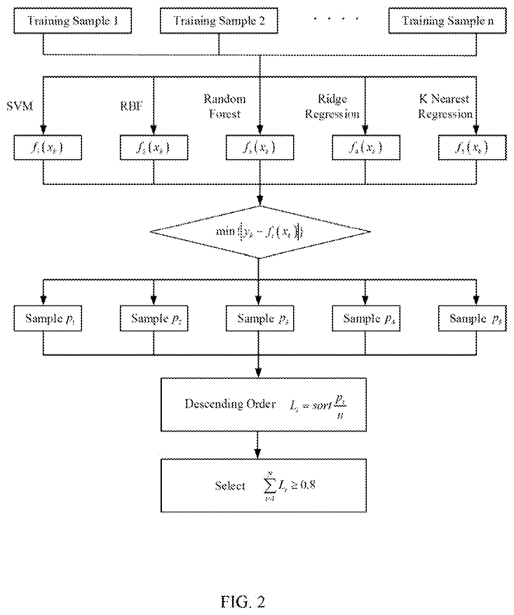

As shown in FIG. 2, the detailed steps for selecting the strategy by the “principal component analysis” method are:

Modeling n train data are modeled by SVM, RBF neural network, random forest, ridge regression and K-nearest neighbor regression respectively, and obtaining five regression equations as g=f1 (x), g=f2 (x), g=f3 (x), g=f4 (x) and g=f5 (x).

\textcircled{2} for any one piece of training data (Xk, Yk), using the above-mentioned five models for prediction to obtain five different output values f1 (Xk), f2 (Xk), f3 (Xk), f4 (Xk) and f5 (Xk), comparing the output value of each method with the true value. The machine learning method corresponding to the minimum error between the output value and the true value is selected as the method used for this piece of data. The comparison formula is as follows:

min{yk−fi(xk)}i=1,2, . . . 5;

\textcircled{3} For all the training data, repeating step \textcircled{2} to obtain the number of samples passed by each machine learning method, which are respectively labeled as p1, p2, p3, p4 and p5, and p1+p2+p3+p4+p5=n is satisfied;

\textcircled{4} Sorting the number of samples obtained in step \textcircled{3} in descending order according to the following formula:

$${L}_{i} = sort ( \frac{{p}_{i}}{n} ) ;$$

\textcircled{5} selecting a machine learning method that meets the conditions to form an individual learning model of the ensemble learning model, and the formula selected is as follows:

$${\sum }_{i = 1}^{m} {L}_{i} \geq 0.8 , m \leq 5 ;$$

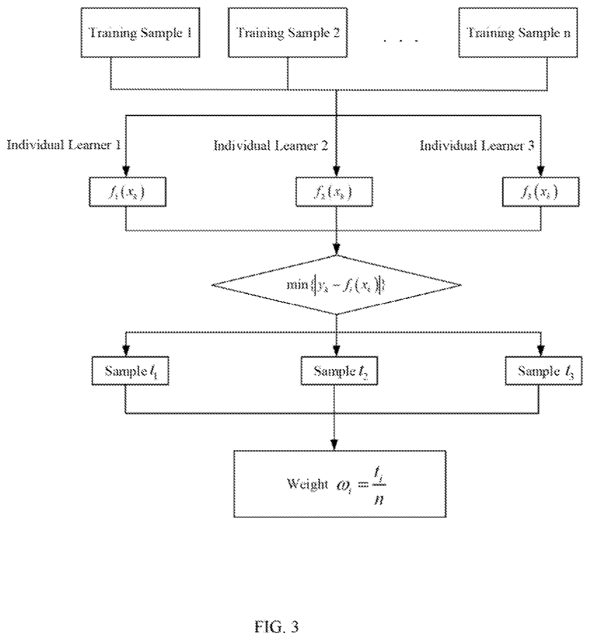

As shown in FIG. 3, the detailed steps of the “principal component weight average” combination strategy are as follows:

\textcircled{1} Three regression equations (f1 (x), f2 (x) and f5 (x) were obtained by modeling n training samples with the first individual learner, the second individual learner and the third individual learner respectively.

\textcircled{2} for any one piece of training data (Xk, Yk), three different output values f1 (xk), f2 (xk) and f3 (xk) are obtained, the output values of each method are compared with the true value respectively. The machine learning method corresponding to the minimum error between the output value and the true value is selected as the method used for this piece of data. The comparison formula is as follows:

min{|yk−f1(Xk)|,|yk−f2(Xk)|,|yk−f3(Xk)}

Repeating step \textcircled{2} for all training data, the number of samples passed by each machine learning method is respectively labeled as t1, t2, t3, and t1+t2+t3=n is satisfied.

\textcircled{4} Calculate the weight factors of each model, the weight formula is as follows:

$$Wi = \frac{- t i}{n} i = 1 , 2 , 3 .$$

What is claimed is:

1. A porosity prediction method based on selective ensemble learning, comprising:
selecting a group of individual learning models adopting the “principal component analysis” method from classical models of a support vector machine, a radical basis function (RBF) neural network, a random forest, a ridge regression and a K-nearest neighbor (KNN) regression to form an integrated learning model;
obtaining a weight of the individual learning model in the integrated learning model by a “principal component weighted average” method;
obtaining an output of the integrated learning model by the weighted average method;
the output model comprises:
A. researching and analyzing typical machine learning methods, and establishing an individual learning model;
B. selecting strategies by adopting the “principal component analysis” method, and selecting some of the individual learning models to form the integrated learning model;
C. using a portfolio strategy of the “principal component weighted average” method to obtain the weight of the individual learning model, and using the weighted average method to obtain the output of the integrated learning model.

2. The porosity prediction method based on selective ensemble learning of claim 1, wherein, in the part A, the individual learning models comprises the support vector machine, the RBF neural network, the random forest, the ridge regression and the K-nearest neighbor regression.

3. The porosity prediction method based on selective ensemble learning of claim 2, wherein, in the part B, the method of the “principal component analysis” is adopted to choose a strategy for selecting a group of excellent individual learning models from classical models of the support vector machine, the RBF neural network, the random forest, the ridge regression and the K-nearest neighbor regression to form the ensemble learning model;
the “principal component analysis” comprises:
using five machine learning methods to learn from a training data, and make predictive analysis to the training data;
comparing a predicted value obtained by the five machine learning methods for each piece of training data with an actual value;
selecting the machine learning method corresponding to a best predicted value as the method used for this training data;
counting the number of samples passed by each machine learning method and the proportion in the total training samples;
selecting several optimal machine learning methods according to the proportion to form the individual learning model of the integrated learning model;
the method of selecting several optimal machine learning methods according to the proportion to form the individual learning model of the integrated learning model further comprises:
\textcircled{1} modeling n training data by the SVM, the RBF neural network, the random forest, the ridge regression and the K-nearest neighbor regression respectively and obtaining five regression equations: G=f1 (x), g=f2 (x), g=f3 (x), g=f4 (x) and g=f5 (x);
\textcircled{2} for any training data (Xk, Yk), five different output values f1 (Xk), f2 (Xk), f3 (Xk), f4 (Xk) and f5 (Xk) can be obtained by using the five models for prediction; selecting the machine learning method corresponding to the minimum error between the output value and the true value as the method used for the data; the comparison formula is as follows: min {|yk−fi (Xk)|} i=1, 2, . . . 5;
\textcircled{3} for all training data, repeating step \textcircled{2} to obtain the number of samples passed by each machine learning method, which are respectively labeled as p1, p2, p3, p4, p5, and p1+p2+p3+p4+p5=n is satisfied;
\textcircled{4} ® sorting the number of samples obtained in step \textcircled{3} in descending order according to the following formula;
$${L}_{i} = sort ( \frac{{p}_{i}}{n} ) ;$$
\textcircled{5} selecting a qualified machine learning method to form the individual learner of the ensemble learning model, and the formula for selection is as follows:
$${L}_{i} = sort ( \frac{{p}_{i}}{n} ) .$$

4. The porosity prediction method based on selective ensemble learning of claim 3, wherein, in the part C, a strategy of the “principal component weighted average” method is adopted to obtain a weight of the individual learning model, and an output of the ensemble learning model is obtained by using a weighted average method;
wherein the “principal component weight average” comprises:
Modeling and predicting the training data, by individual learners and each item is trained;
comparing the predicted value and the true value obtained by the individual learners for each training data;
selecting the individual learner corresponding to the best prediction value as the model used for the data;
and counting the number of samples passed by each learner and the proportion, which is the weighting factor of the learner, in the total training samples;
wherein the detailed steps are:
\textcircled{1} modeling n training samples by a first individual learner, a second individual learner and a third individual learner, and obtaining three regression equations f1 (x), f2 (x) and f5 (x);
\textcircled{2} for any one piece of training data (Xk, Yk), three different output values f1 (xk), f2 (xk) and f3 (xk) are obtained, respectively
comparing the three output values of each method the true value, and the machine learning method corresponding to the minimum error between the output value and the real value is selected;
the comparison formula is:
min{|yk−f1(xk)|,|yk−f2(xk)|,|yk−f3(xk)|}
\textcircled{3} for all the training data, repeating the step \textcircled{2} to obtain the number of samples passed by each machine learning method, which are respectively labeled as t1, t2 and t3, and t1+t2+t3=n is satisfied;
\textcircled{4} calculating the weight factors of each model and the weight formula is:
$$Wi = \frac{- ti}{n} i = 1 , 2 , 3.$$
